(19) United States
(12) Patent Application Publication
(10) Pub. No.: US 2026/0145620 A1
(43) Pub. Date: May 28, 2026

(54) ADJUSTABLE TIRE RACK

(71) Applicant: Outlier Campers LLC, Cambridge, MA (US)

(72) Inventor: Ananda Wickramasekera, Cambridge, MA (US)

(21) Appl. No.: 19/173,300

(22) Filed: Apr. 8, 2025

Related U.S. Application Data
(60) Provisional application No. 63/725,765, filed on Nov. 27, 2024.

(51) Int. Cl. B60R 9/06

(52) U.S. Cl. CPC B60R 9/06

(57) ABSTRACT

An adjustable tire rack mounts to a vehicle spare tire; has a vertical center plate; has two vertical side plates that are perpendicular to the center; adjusts to accommodate tires of various sizes between the two vertical side plates; may contain pivotable brackets to adjust to the curvature of various tires; may have a portion of the side plates that extends away from the tire and the center plate; and may contain MOLLE-type holes, spacing, and mounting features.

### CROSS-REFERENCE TO RELATED APPLICATIONS

This application claims under 35 U.S.C. § 119(e) the benefit of U.S. Provisional Patent Application No. 63/725,765 filed Nov. 27, 2024, and titled “ADJUSTABLE TIRE RACK,” the disclosure of which is hereby incorporated herein by reference in its entirety.

### TECHNICAL FIELD

The present disclosure relates to an adjustable tire rack designed to securely hold and fasten tires of various sizes using pivotable brackets, straps, and a configurable center plate.

### BACKGROUND

Existing spare tire racks (i.e., storage racks mountable to vertically mounted spare tires) typically do not: adjust to fit the diameter of various tire sizes; have a fixed curvature that may not precisely fit tires of various diameters; have vertical mounting surfaces that extend substantially beyond the tire; and extend around the sides and front of the tire at its widest portion (e.g., across the tread surfaces, sides, or ends of the tire; and across the front of the tire (e.g., including the front of the rim and side walls), at the tire's diameter or center).

It would be beneficial for a spare tire rack to be vertically mountable to a spare tire at or near its diameter (e.g., widest part of the tire), have portions that extend across the front of the tire and the tread surfaces on each side; be adjustable to fit tires of various sizes and curvatures (e.g., at the portion where the rack would come in contact with the tire); contain additional storage surfaces that extend away from the tire (e.g., away from the front of the tire); and contain spaces, holes, slots, gaps, notches, mounts, and/or other mounting features that are compatible with the MOLLE standard or system.

The adjustable tire rack described herein adds storage surfaces to spare tires of various sizes. It may contain a vertical center plate with a mounting surface capable of extending across the front of the tire, at its widest part. The center plate may be fixed or adjustable in width. The center plate may be divided into two or more halves with an optional leaf to extend the mounting surface. The adjustable tire rack may also contain two vertical side plates with mounting surfaces that are perpendicular to the center plate mounting surface and may extend across all or a portion of the sides or tread surfaces of the tire and may contain the tire therebetween. The side plates may further contain attachable or fixed extensions or “wings” that may extend away from the tire and center plate, which may offer additional mounting surfaces. The adjustable tire rack may be adjustable in width or may contain brackets that are adjustable in width and/or may pivot to account for tires of various sizes and/or curvatures. The adjustable tire rack may also contain holes, spaces, slots, gaps, mounts, and/or other mounting features that are compatible with the MOLLE standard or system; and/or may contain other holes, spaces, slots, gaps, grooves, notches, screw holes, screws, brackets, mounts, and/or other mounting features to mount or store gear, supplies, components, storage bags, storage cases, and/or other items.

### SUMMARY OF DISCLOSURE

The adjustable tire rack described herein may contain a tire therebetween; may contain mounting surfaces that extend across all or a portion of the front and sides of a tire; may adjust in width to accommodate tires of various sizes; may adjust in curvature to accommodate various curvatures of tires (e.g., where the tire engagement portions of the rack contact the tire); may contain portions with mounting surfaces that extend away from the tire (e.g., away from the front of the tire); and may contain mounting features (e.g., holes, spaces, gaps, groves, slots, notches, screw holes, screws, brackets, mounts, and/or other mounting features) that are MOLLE standard and/or non-MOLLE standard.

The adjustable tire rack described herein may be adjustable to accommodate tires of various sizes by containing adjustable side plates or adjustable portions of side plates that engage with the tire (e.g., the side plates or portions of them may move inward toward each other or outward away from each other to fit around and contain tires of various diameters therebetween). The side plates or portions of the side plates may be adjusted to fit a tire between them, then fastened with straps around, across, and/or through the tire, including the rim, thereby securing the rack to the tire. The adjustable tire rack may also contain a center plate, slidably attached to each of two side plates, which may either be fixed or adjustable in width.

The adjustable tire rack described herein may contain a vertical center plate, as mentioned above, with a mounting surface capable of extending across all or a portion of the front of a tire, at its widest portion (e.g., across the center of the front of the rim and tire side walls). The center plate may be fixed or adjustable in width (e.g., to accommodate tires of various sizes). Whether fixed or adjustable, the center plate may have a screw that may slide along a slot, track, grove, rail, or may be positioned into one of several holes at various positions on each of two side plates or on a bracket on each side plate that connects the side plate to the center plate and fastened; or it may be fastened by another fastening mechanism. Or the center plate may contain a slot, track, grove, rail, or one of several holes at various positions that a screw on each of two side plates or on a bracket on each side plate that connects the side plate to the center plate may be able to slide along or be positioned at and fastened; or it may be fastened by another fastening mechanism. The center plate may be divided into two or more halves or portions connected by one or more rails along which the center plate portions may slide or be positioned closer together or further apart, and may contain an optional leaf to expand the mounting surface, attachable to said rail, if the center plate is adjustable in width. The center plate may contain holes, spaces, gaps, groves, slots, notches, screw holes, screws, brackets, mounts, and/or other mounting features that are compatible with the MOLLE standard or system; and/or the center plate may contain non-MOLLE holes, spaces, gaps, grooves, slots, notches, screw holes, screws, brackets, mounts, and/or other mounting features to attach items for storage on the rack.

The adjustable tire rack described herein may also contain two vertical side plates, as mentioned above, with mounting surfaces that may extend across all or a portion of the sides or tread surfaces of the tire, may contain the tire therebetween, and may be perpendicular to the center plate. Each side plate may be adjustable or may contain adjustable portions to accommodate tires of various sizes between them (e.g., the side plates or portions of them may move closer together or further apart to adjust for tires of various diameters). Whether the center plate is fixed or adjustable in width, each of two side plates or a bracket on each side plate that connects the side plate to the center plate may have a screw that may slide along a slot, track, grove, rail, or may be positioned into one of several holes at various positions on the center plate and fastened; or it may be fastened by another fastening mechanism. Or each of two side plates or a bracket on each side plate that connects the side plate to the center plate may contain a slot, track, grove, rail, or one of several holes at various positions that a screw on the center plate may be able to slide along or be positioned at and fastened; or it may be fastened by another fastening mechanism. Each side plate may contain holes, spaces, gaps, groves, slots, notches, screw holes, screws, brackets, mounts, and/or other mounting features that are compatible with the MOLLE standard or system; and/or each side plate may contain non-MOLLE holes, spaces, gaps, grooves, slots, notches, screw holes, screws, brackets, mounts, and/or other mounting features to attach items for storage on the rack.

Each of two side plates may contain one or more brackets which may be used to detachably connect the adjustable tire rack to a tire. Each bracket may be pivotable to adjust for the curvature of tires of various diameters. Each bracket may contain an upper engagement portion and a lower engagement portion to connect the adjustable tire rack to an upper portion and a lower portion, respectively, of a tire. Each bracket may contain first and second slots in the upper and lower engagements portions, respectively, that may be in line with the curvature of the tire and may allow a strap to be passed through them and around the tire (e.g., around the circumference of the tire) to detachably connect the rack to a tire. Each bracket may also contain third and fourth slots in the upper and lower engagement portions, respectively, that may be perpendicular to the direction of the curvature of the tire and may allow a strap to be passed through each of them and around the sides (e.g., across tread surfaces, front, and rear of the tire), and/or may allow a strap to be passed through each of them and around the sides of the tire and through the rim of the tire (e.g., across the tread surface, the side walls of the tire, and through a hole in the rim of the tire) to detachably connect the rack to a tire. Either the first and second slots or the third and fourth slots or a combination of the first, second, third, and fourth slots on each bracket may be used to detachably and securely attach the adjustable tire rack to a tire.

If the adjustable tire rack contains a fixed center plate and two fixed side plates that are perpendicular to the center plate (e.g., each of two side plates is perpendicularly fixed, in a non-adjustable way, to the center plate, which is also fixed in width and non-adjustable), each of the two side plates may contain adjustable portions to adjust to various diameters or widths of tires. In this configuration, the engagement portions of each bracket on each side plate may be adjusted to move further away from or closer to the side plate to accommodate tires of various sizes between the two side plates. Each bracket may then contain a fixed portion (e.g., portion that is fixed to the side plate) and an adjustable portion (e.g., a portion that may be adjustable to accommodate tires of various sizes). The fixed portion of each bracket may have a screw that may slide along a slot, track, grove, rail, or may be positioned into one of several holes at various positions on the adjustable portion of the bracket and fastened; or it may be fastened by another fastening mechanism. Or the fixed portion of each bracket may contain a slot, track, grove, rail, or one of several holes at various positions that a screw on the adjustable portion of the bracket may be able to slide along or be positioned at and fastened; or it may be fastened by another fastening mechanism. The adjustable portion of each bracket may be moved outward or inward to accommodate tires of various diameters. The adjustable portion of each bracket may contain the tire engagement portion (e.g., the portion that contacts a tire surface and is secured to the tire with one or more straps) which may be pivotable and/or may contain the first and second slots and/or the third and fourth slots on the upper and lower engagement portions, respectively, as mentioned above, to fit various tire diameters and curvatures and to detachably and securely fasten the rack to the tire.

Each of two side plates may further contain attachable or fixed extensions or “wings” that may extend away from the tire and center plate. The wings may add additional mounting surfaces to the rack that extend the side plates beyond the portions of the rack that surround the tire. If the wings are detachably connected to the rack, they may contain brackets that are attachable to either the side plates or to the center plate. Each wing on each side plate may contain holes, spaces, gaps, groves, slots, notches, screw holes, screws, brackets, mounts, and/or other mounting features that are compatible with the MOLLE standard or system; and/or each side plate may contain non-MOLLE holes, spaces, gaps, grooves, slots, notches, screw holes, screws, brackets, mounts, and/or other mounting features to attach items for storage on the rack. An object may be secured onto just the portion of the side plate that abuts the tread surface of the tire, onto just the wing portion of the side plate that extends away from the tire, or onto and across both portions.

In addition to the vertical center and side plates, the frame of the adjustable tire rack may itself contain holes, spaces, gaps, grooves, slots, notches, screw holes, screws, brackets, mounts, and/or other mounting features to attach items for storage directly to the frame of the rack, on any portion of the frame that can support an item and/or its mount.

### BRIEF DESCRIPTION OF DRAWINGS

FIG. 1 shows a perspective view of an exemplary adjustable tire rack with an exemplary tire therebetween, according to some embodiments of the present disclosure;

FIG. 2 shows a perspective view of the exemplary adjustable tire rack with an exemplary tire therebetween of FIG. 1 mounted on a vehicle;

FIG. 3 shows a left, front perspective view of the exemplary adjustable tire rack of FIG. 1 with an exemplary small tire therebetween;

FIG. 4 shows a left, front perspective view of the exemplary adjustable tire rack of FIG. 1 with an exemplary large tire therebetween;

FIG. 5 shows a rear perspective view of the center plate of the exemplary adjustable tire rack of FIG. 1;

FIG. 6 shows a rear perspective view of the brackets and slots of the exemplary adjustable tire rack of FIG. 1 on one side;

FIG. 7 shows a rear perspective view of the brackets and slots of FIG. 6 with straps attached to an exemplary tire on one side;

FIG. 8 shows a perspective view of another exemplary adjustable tire rack with another exemplary tire therebetween, according to some embodiments of the present disclosure;

FIG. 9 shows a perspective view of the exemplary adjustable tire rack with an exemplary tire therebetween of FIG. 8 mounted on a vehicle;

FIG. 10 shows a left, front perspective view of the exemplary adjustable tire rack of FIG. 8 with an exemplary large tire therebetween;

FIG. 11 shows a left, front perspective view of the exemplary adjustable tire rack of FIG. 8 with an exemplary small tire therebetween;

FIG. 12 shows a top, rear perspective view of the brackets, slots, and straps of the exemplary adjustable tire rack with exemplary tire therebetween of FIG. 8; and

FIG. 13 shows a bottom, rear perspective view of the brackets, slots, and straps of the exemplary adjustable tire rack with exemplary tire therebetween of FIG. 8.

While the disclosure is susceptible to various modifications and alternative forms, specific embodiments thereof have been shown by way of example in the drawings and are herein described in detail. It should be understood, however, that the description herein of specific embodiments is not intended to limit the disclosure to the particular forms disclosed, but on the contrary, the intention is to cover all modifications, equivalents, and alternatives falling within the spirit and scope of the disclosure as defined by the appended claims.

### DETAILED DESCRIPTION OF SPECIFIC EMBODIMENTS

Described herein are devices, components, assemblies, systems, methods, etc. for adjustable tire racks. The description and accompanying figures, which describe and show certain embodiments, are made to demonstrate, in a non-limiting manner, several possible configurations of adjustable tire racks, apparatuses, components, assemblies, systems, etc. and various methods of using them according to various aspects and features of the present disclosure. Accordingly, the disclosure is not limited to the specific embodiments described. Rather, the inventive principles associated with the embodiments described herein, including with respect to the apparatuses, devices, components, assemblies, systems, methods, etc. described herein, may be applied in a variety of ways, including to other types of apparatuses, devices, components, assemblies, systems, methods, etc.

General and specific apparatuses, devices, components, assemblies, systems, methods, etc. are described herein sufficiently to enable one to develop a variety of implementations/applications without undue experimentation. In the development of particular applications, numerous implementation-specific decisions will be made to achieve the design-specific goals, which will vary from one implementation/application to another. It will be appreciated that, having access to this disclosure and reading this disclosure, such a development effort would be a routine undertaking for persons of ordinary skill in the art.

This document does not intend to distinguish between components that differ in name but not function. In the following discussion and in the claims, the terms “including,” “includes,” “comprising,” “have,” and “has” are used in an open-ended fashion, and thus should be interpreted to mean “including, but not limited to.” The word “or” is used in the inclusive sense (i.e., “and/or”) unless a specific use to the contrary is explicitly stated.

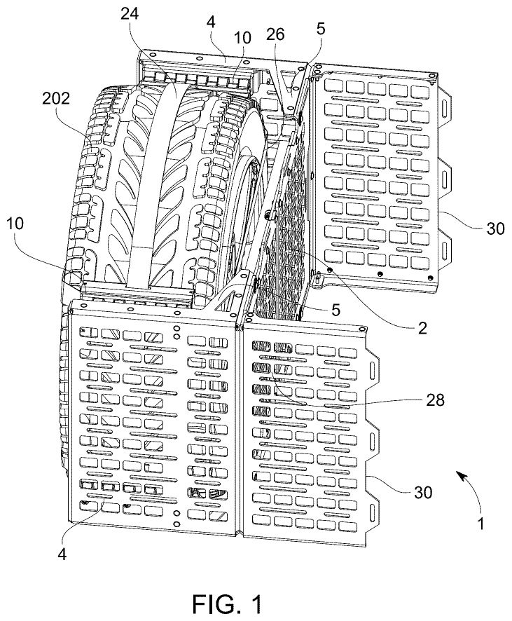

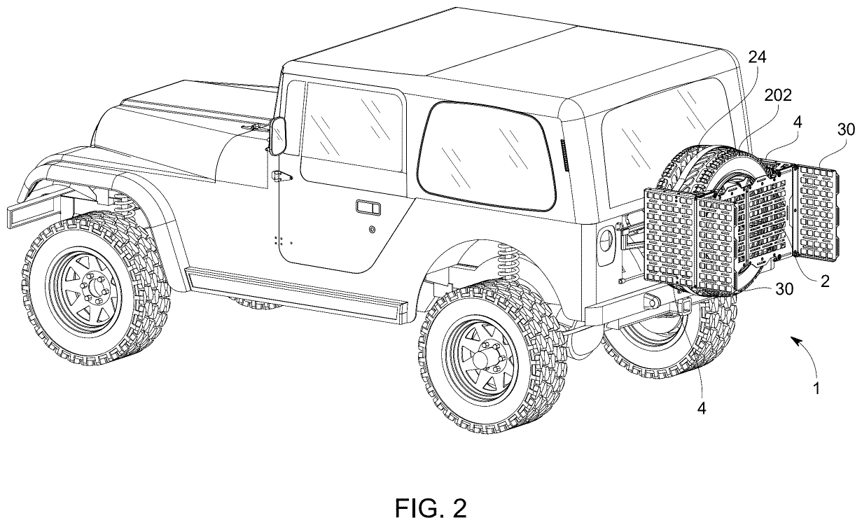

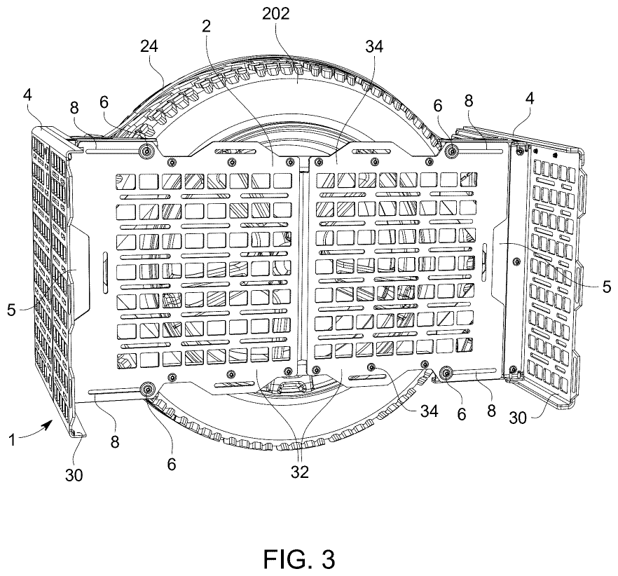

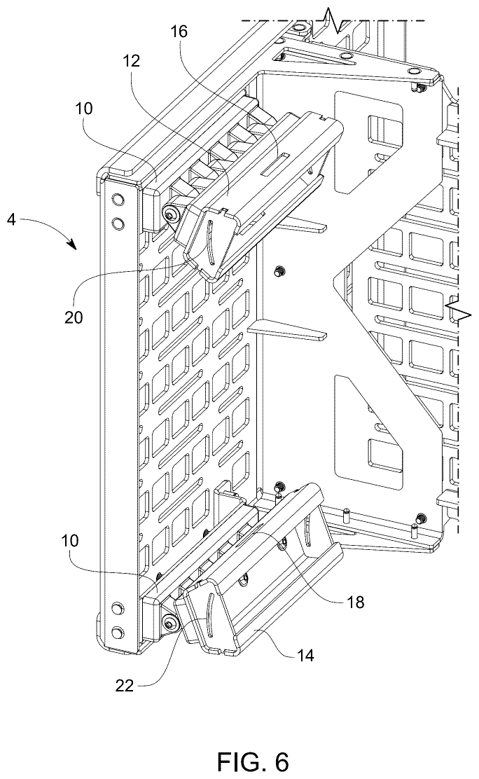

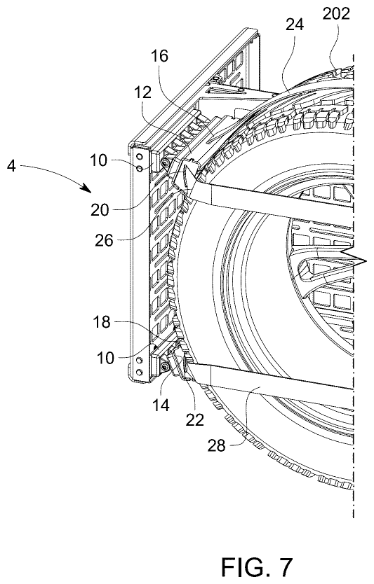

Adjustable tire rack 1 may contain a tire therebetween, as shown in FIG. 1, which may be mounted to a vehicle, as shown in FIG. 2; may contain mounting surfaces that extend across all or a portion of the front and sides of a tire, as shown in FIGS. 1 and 2; may adjust in width to accommodate tires of various sizes, as shown in FIGS. 3-5; may adjust in curvature to accommodate various curvatures of tires (e.g., where the tire engagement portions of the rack contact the tire), as shown in FIGS. 6 and 7; may contain portions that extend away from the tire (e.g., away from the front of the tire), as shown in FIGS. 1-5; and may contain mounting features (e.g., holes, spaces, gaps, groves, slots, notches, screw holes, screws, brackets, mounts, and/or other mounting features) that are MOLLE standard and/or non-MOLLE standard, as also shown in FIGS. 1-5.

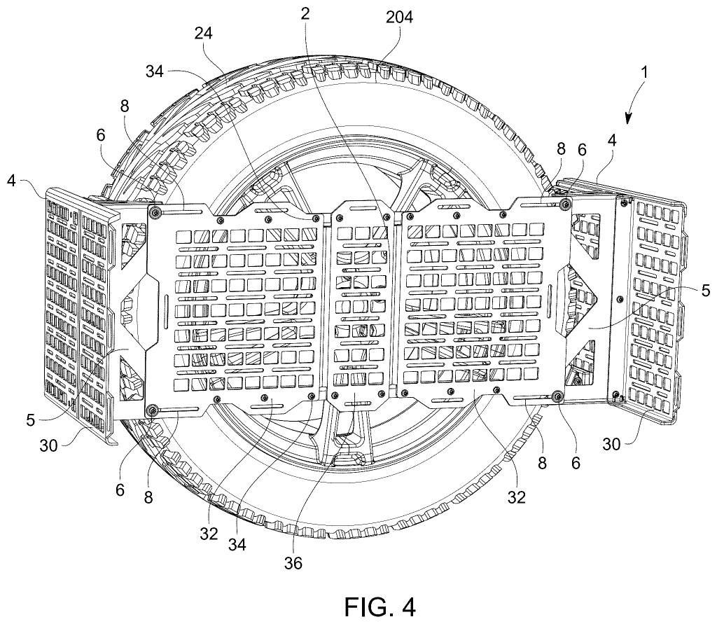

Adjustable tire rack 1 described herein and shown in FIGS. 1-5 may be adjustable to accommodate tires of various sizes by containing adjustable side plates that engage with the tire (e.g., the side plates on opposing sides may move inward toward each other or outward away from each other to contain tires of various diameters therebetween). Two of side plates 4 may be adjusted to fit tire 202, as shown in FIG. 1-3, or tire 204, as shown in FIG. 4, between them, then fastened with straps 24, 26, and/or 28 around, across, and/or through tires 202 or 204, respectively, and/or including their rims, thereby securing adjustable tire rack 1 to tires 202 or 204, respectively. Adjustable tire rack 1 may also contain center plate 2, slidably attached to each of two side plates 4, as shown in FIGS. 1-5. Adjustable tire rack 1 may also contain one of wings 30 detachably connected to each of side plates 4, as shown in FIGS. 1-5.

Adjustable tire rack 1, as shown in FIGS. 1-5, may contain center plate 2, as mentioned above, which may be a vertical plate with a mounting surface capable of extending across all or a portion of the front of small tire 202 (shown in FIGS. 1-3) or large tire 204 (shown in FIG. 4), at their widest portions (e.g., across the diameter of the tire, including the front of the rim and tire side walls) and capable of adjusting in width (e.g., to accommodate tires of various sizes).

Center plate 2 may contain one or more of slots 8, each of which may be a slot, track, grove, rail, or one of several holes at various positions that one of screws 6 on each of side plates 4 may be able to slide along or be positioned at and fastened, as shown in FIGS. 3 and 4. Alternatively, center plate 2 may have one or more screws that may slide along a slot, track, grove, rail, or may be positioned into one of several holes at various positions on each of two side plates 4 and fastened.

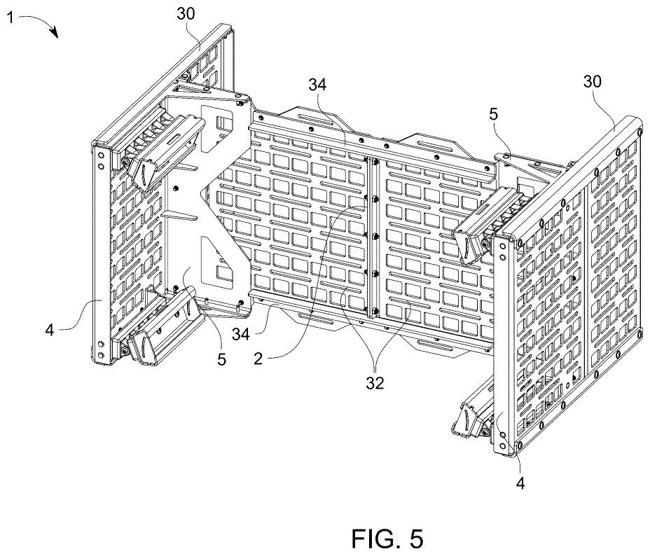

As shown in FIGS. 3-5, center plate 2 may be divided into two of halves 32, which be positioned at various locations on rail 34, as shown in detail in FIG. 5, which may be a rail, track, groove, slot, bracket, or attachment that may contain several holes at various locations to which each of halves 32 may be positioned along or at and fastened (e.g., two of halves 32 may be positioned on rail 34 away from each other to widen center plate 2 or near each other to narrow center plate 2, then fastened in position) and may contain leaf 36, also fastened to rail 34, between two of halves 32, to expand the mounting surface.

As shown in FIG. 3, center plate 2 may be adjusted to fit small tire 202, by loosening each of screws 6 on each of side plates 4 that are passing through one of slots 8 on center plate 2, and moving each of halves 32 of center plate 2 toward each other (e.g., along rail 34), then fastening each of screws 6 through one of slots 8, securing center plate 2 to each of side plates 4 and onto small tire 202. As shown in FIG. 4, center plate 2 may be adjusted to fit large tire 204, by loosening each of screws 6 on each of side plates 4 that are passing through one of slots 8 on center plate 2, and, if needed, moving each of halves 32 of center plate 2 away from each other (e.g., along rail 34), then fastening each of screws 6 through one of slots 8, securing center plate 2 to each of side plates 4 and onto large tire 204. As shown in FIG. 3, halves 32 of center plate 2 may be abutted at adjustable tire rack 1's narrowest position to accommodate small tire 202. As shown in FIG. 4, halves 32 of center plate 2 may be spread to their furthest positions away from each other at adjustable tire rack 1's widest position, if needed, to accommodate large tire 204, and at that position leaf 36 may be placed between halves 32 to increase center plate 2's mounting surface area.

As shown in FIG. 5, the screws securing halves 32 of center plate 2 to rail 34 of center plate 2 may be loosened or removed to reposition each of halves 32 to widen or narrow center plate 2 and fastened at a width between the minimum width shown in FIG. 3 and the maximum width shown in FIG. 4. Adjustable tire rack 1 may be adjusted to the narrowest position shown in FIG. 3, the widest position shown in FIG. 4, or a position between those positions. Center plate 2 may contain holes, spaces, gaps, groves, slots, notches, and/or screw holes, as shown in FIGS. 1-5, that are both complaint with and non-compliant with (e.g., outside of) the MOLLE standard or system; and/or center plate 2 may contain screws, brackets, mounts, and/or other mounting features that are both compliant with and non-compliant with (e.g., outside of) the MOLLE standard or system to attach items for storage on adjustable tire rack 1.

Adjustable tire rack 1, as shown in FIGS. 1-5, may also contain one or more of side plates 4, as mentioned above, which may be vertical side plates with mounting surfaces that may extend across all or a portion of the sides or tread surfaces of small tire 202 (shown in FIGS. 1-3) or large tire 204 (shown in FIG. 4), may contain the tire therebetween, and may have mounting surfaces that are perpendicular to center plate 2's mounting surface, with one of side plate 4 on a first side of center plate 2 and one of side plate 4 on a second side of center plate 2, such that center plate 2 and two of side plates 4 surround a front side and two sides (e.g., tread surfaces) of small tire 202 or large tire 204. Each of side plates 4 may be adjustable to accommodate tires of various sizes between them (e.g., two of side plates 4 on opposing sides of adjustable tire rack 1 may move closer together or further apart to adjust for tires of various diameters).

As shown in FIGS. 1 and 5, each of side plates 4 may contain corner bracket 5, which may be an angled bracket that runs part or all of the length from an upper area of side plate 4 to lower area of side plate 4 and that may be used to attach side plate 4 to center plate 2. Each of two side plates 4 may have one or more of screws 6 (e.g., located on each corner bracket 5 as previously shown in FIG. 1), which may be a hand screw, thumb screw, bolt, nut, and/or any type of fastening mechanism, which may slide through and along slot 8 in center plate 2 and fastened, as shown in FIGS. 3-5. Alternatively, each of side plates 4 and/or their corner brackets 5 may contain one or more slots, tracks, groves, rails, or several holes at various positions that a screw on center plate 2 may be able to slide along or be positioned at and fastened.

As shown in FIG. 3, each of side plates 4 may be adjusted to fit small tire 202, by loosening each of screws 6 (on corner bracket 5 shown previously in FIG. 1) on each of side plates 4 that are passing through one of slots 8 on center plate 2, and moving two of side plates 4 toward each other, then fastening each of screws 6 through one of slots 8, securing each of side plates 4 to center plate 2 and onto tire 202. As shown in FIG. 4, center plate 2 may be adjusted to fit large tire 204, by loosening each of screws 6 (on corner bracket 5 shown previously in FIG. 1) on each of side plates 4 that are passing through one of slots 8 on center plate 2, and moving two of side plates 4 away from each other, then fastening each of screws 6 through one of slots 8, securing each of side plates 4 to center plate 2 and onto tire 204.

As shown in FIG. 3, two of side plates 4 may be at their closest position to each other at adjustable tire rack 1's narrowest position to accommodate small tire 202. As shown in FIG. 4, side plates 4 may be at their furthest positions away from each other at adjustable tire rack 1's widest position to accommodate large tire 204. As mentioned above, adjustable tire rack 1 may be adjusted to the narrowest position shown in FIG. 3, the widest position shown in FIG. 4, or a position between those positions shown in FIGS. 3 and 4. Each of side plates 4 may contain holes, spaces, gaps, groves, slots, notches, and/or screw holes that are both compliant with and non-compliant with (e.g., outside of) the MOLLE standard or system; and/or each of side plates 4 may contain screws, brackets, mounts, and/or other mounting features that are both compliant with and non-compliant with (e.g., outside of) the MOLLE standard or system to attach items for storage on adjustable tire rack 1.

As shown in FIGS. 6 and 7, side plate 4 may contain bracket 10, which may be a pivotable bracket used to detachably connect adjustable tire rack 1 to tires of various diameters. Bracket 10 may contain upper engagement portion 12, as shown in FIGS. 6 and 7, which may engage with an upper portion of tire 202, as shown in FIG. 7; and bracket 10 may also contain lower engagement portion 14, as shown in FIGS. 6 and 7, which may engage with a lower portion of tire 202, as shown in FIG. 7. Upper engagement portion 12 and lower engagement portion 14 may each be pivotable to fit the curvature of various tire sizes (e.g., various diameters) and/or to adjust to various vertical positions adjustable tire rack 1 may be positioned at with respect to a tire (e.g., at or near the top, at or near the center, at or near the bottom, or at any other position on the tire). As also shown on FIGS. 6 and 7, upper engagement portion 12 may contain first slot 16 and lower engagement portion 14 may contain second slot 18. Slots 16 and 18 may be slots capable of accepting strap 24 passed through them as well as around the tire (e.g., around the circumference of the tire) to detachably connect adjustable tire rack 1 to tire 202, as shown in FIG. 7.

As also shown in FIGS. 6 and 7, upper engagement portion 12 may further contain third slot 20 and lower engagement portion 14 may further contain fourth slot 22. Slots 20 and 22 may allow straps 26 and 28, respectively, to be passed through them as well as around the sides of tire 202 (e.g., across tread surfaces, front, and rear of the tire), as shown in FIG. 7. Adjustable tire rack 1 may contain one of: side plate 4; bracket 10; upper engagement portion 12; lower engagement portion 14; slots 16, 18, 20, and 22; and straps 24, 26, and 28 on a first, rear side, as shown in FIG. 7, and adjustable tire rack 1 may contain one of: side plate 4; bracket 10; upper engagement portion 12; lower engagement portion 14; slots 16, 18, 20, and 22; and straps 24, 26, and 28 on a second side, rear side, as a mirror image to the first side shown in FIG. 7, such that strap 24 may pass through a first set of slots 16 and 18 on a first side of adjustable tire rack 1, through a second set of slots 16 and 18 on a second side of adjustable tire rack 1, as well as around the circumference of tire 202 and, when buckled and tightened, strap 24 may secure adjustable tire rack 1 to tire 202.

Similarly, strap 26 may pass through a first slot 20 on a first side of adjustable tire rack 1, through a second slot 20 on a second side of adjustable tire rack 1, as well as around the front, back, and sides (e.g., tread surfaces), near the top, of tire 202, also securing adjustable tire rack 1 to tire 202. Similarly, strap 28 may pass through a first slot 22 on a first side of adjustable tire rack 1, through a second slot 22 on a second side of adjustable tire rack 1, as well as around the front, back, and sides (e.g., tread surfaces), near the bottom, of tire 202, also securing adjustable tire rack 1 to tire 202. Alternatively, a first strap may pass diagonally through slot 20 on an upper side of a first side of adjustable tire rack 1, through slot 22 on a lower side of a second side of adjustable tire rack 1, as well as around the front, back, and sides (e.g., tread surfaces) near both the top and bottom of a tire; and a second strap may pass through slot 22 on a lower side of a first side of adjustable tire rack 1, through slot 20 on an upper side of a second side of adjustable tire rack 1, as well as around the front, back, and sides (e.g., tread surfaces) near both the bottom and top of a tire to secure adjustable tire rack 1 to the tire using two straps in a crisscross pattern.

In another configuration, one of four straps may pass through each of slots 20 and 22 on a first side of adjustable tire rack 1 and through each of slots 20 and 22 on a second side of adjustable tire rack 1, where the each of four straps passes through a respective slot and through the tire (e.g., including the rim of a tire), where each slot and strap may independently or together with other slots and straps secure adjustable tire rack 1 to a tire. One or more of straps 24, 26, or 28 by itself or in combination with other straps may be used to secure adjustable tire rack 1 to tire 202.

Each side plate 4 may further contain a detachably connected wing 30 that may extend away from tire 202 and center plate 2, as shown in FIGS. 1-5. Each of wings 30 may add additional mounting surfaces to adjustable tire rack 1 by extending the mounting surface on each of side plates 4 beyond the portions of adjustable tire rack 1 that surrounds tire 202, as shown in FIGS. 1-4. Wing 30 may be detachably connected to side plate 4 and/or to center plate 2 with screws and/or other fasteners through holes in side plate 4 and/or center plate 2, as shown in FIGS. 1-5. Each of wings 30 may contain holes, spaces, gaps, groves, slots, notches, screw holes, screws, brackets, mounts, and/or other mounting features that are compatible with the MOLLE standard or system; and/or each of wings 30 may contain non-MOLLE holes, spaces, gaps, grooves, slots, notches, screw holes, screws, brackets, mounts, and/or other mounting features to attach items for storage on adjustable tire rack 1. Each of wings 30 detachably connected to a side plate 4 and/or to center plate 2 on each side of adjustable tire rack 1 may extend the mounting surfaces on each side of adjustable tire rack 1, as mentioned and shown in FIGS. 1-5, where an object may be secured onto a side of adjustable tire rack 1, to the main portion of side plate 4 (e.g., the portion that abuts the tread surface of tire 202), to the extended portion in wing 30 (e.g., that extends away from center plate 2 and tire 202), or across the main portion of side plate 4 and its extended portion in wing 30.

The frame and mounting surfaces of adjustable tire rack 1 may be comprised mainly of aluminum, steel, another metal or alloy, another suitable, strong, and rigid material, and/or a combination of materials. The smaller components of adjustable tire rack 1, such as the tire engagements portions, may be comprised mainly of aluminum, steel, another metal or alloy, plastic, rubber, composite material, another suitable material, and/or a combination of materials. The straps used to secure adjustable tire rack 1 to a tire may be mainly comprised of nylon, polyester, another strapping material, and/or a combination of materials. The components that comprise adjustable tire rack 1 may be welded together, screwed together, strapped together, fastened together by another method, and/or fastened together by a combination of methods.

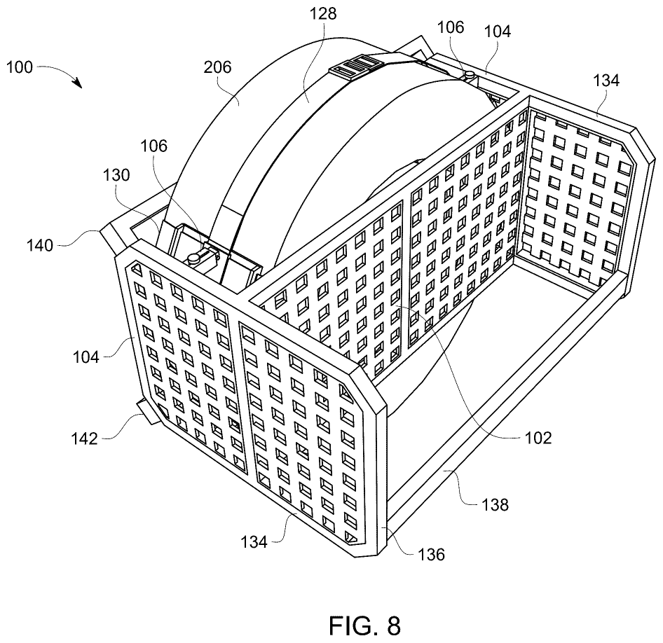

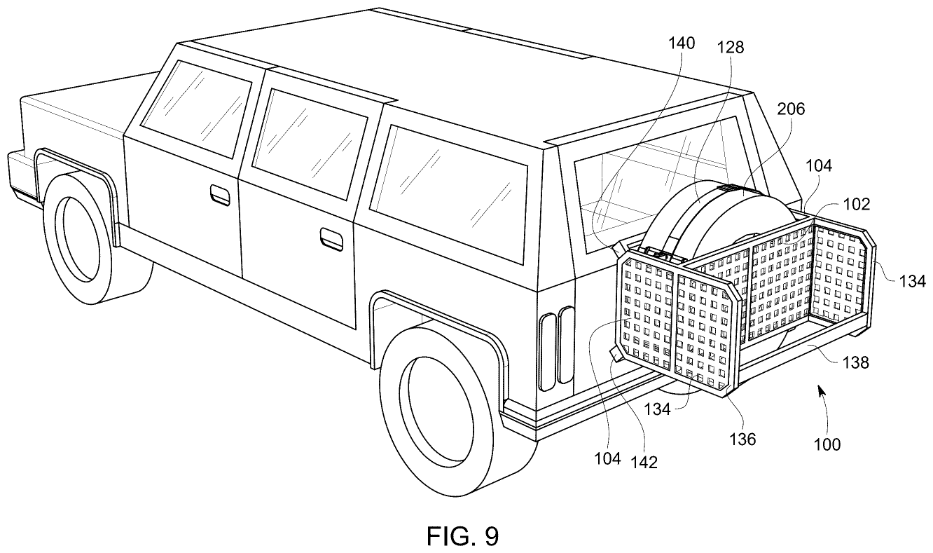

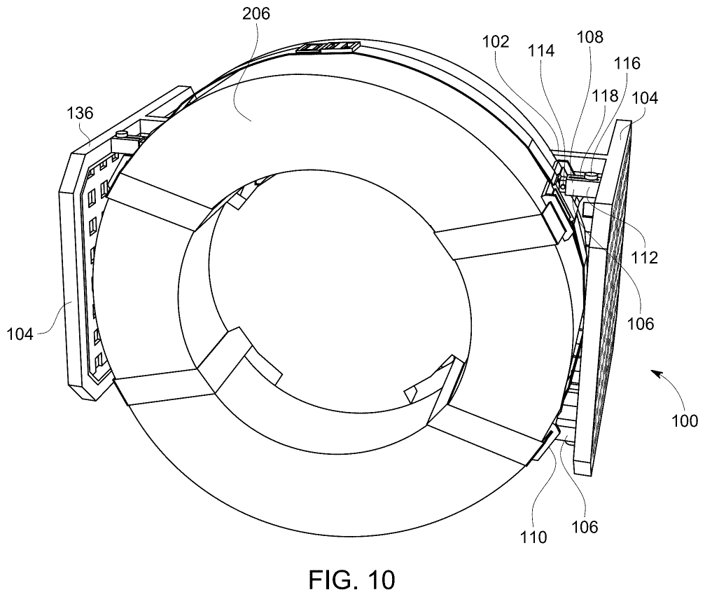

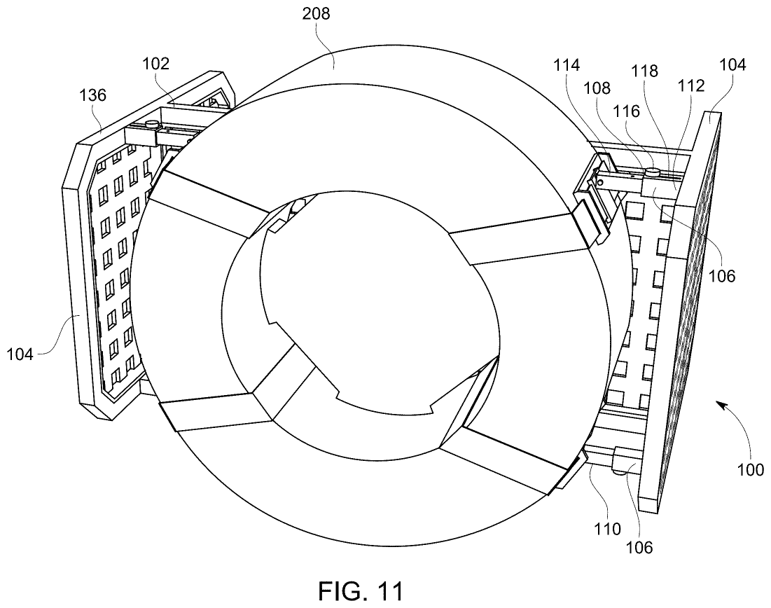

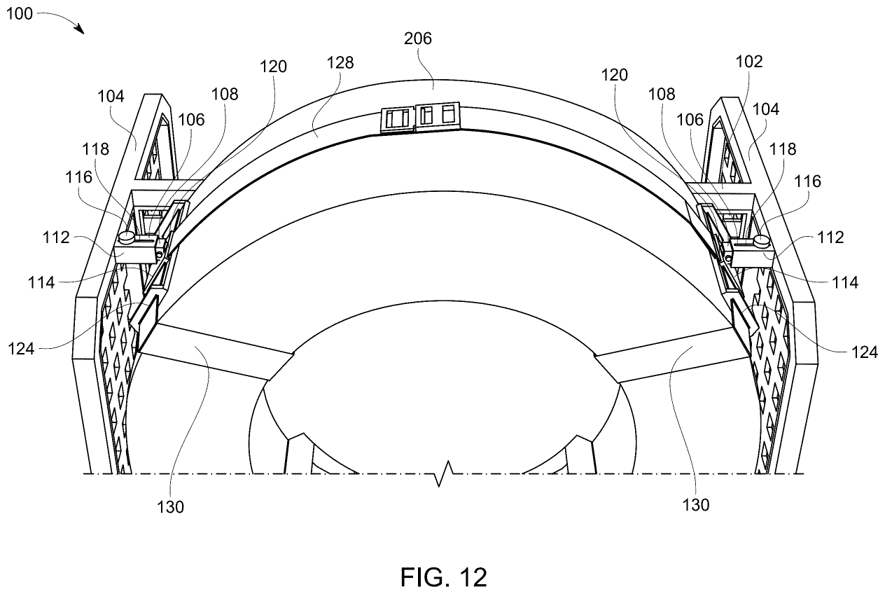

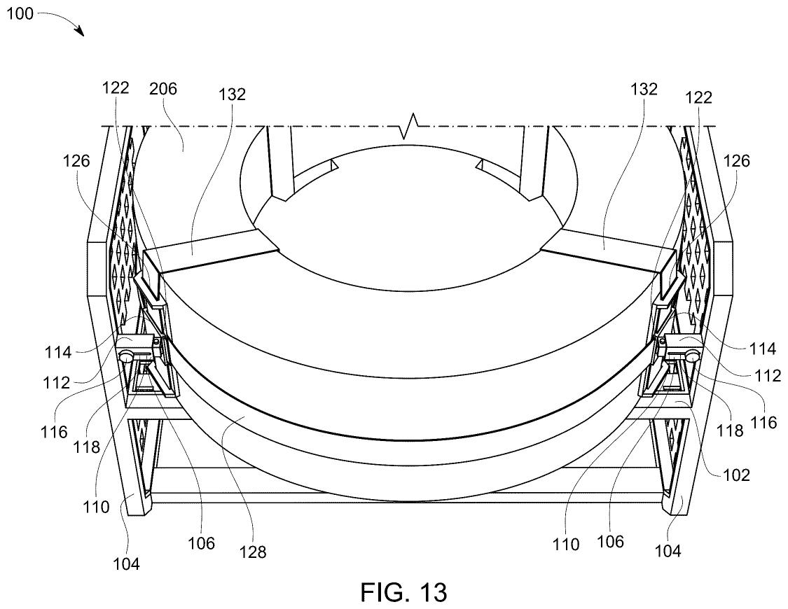

Another embodiment of the adjustable tire rack described herein may be adjustable tire rack 100, which may be like adjustable tire rack 1 and may contain some of the same benefits, features, and/or components. Adjustable tire rack 100 may contain a tire therebetween, as shown in FIG. 8, which may be mounted to a vehicle, as shown in FIG. 9; may contain mounting surfaces that extend across all or a portion of the front and sides of a tire, as shown in FIGS. 8 and 9; may be fixed in width (e.g., contain a fixed, non-adjustable frame), however, may contain adjustable tire engagement portions to accommodate tires of various sizes, as shown in FIGS. 10 and 11; may contain tire engagement portions that adjust in curvature to accommodate various curvatures of tires (e.g., where the tire engagement portions of the rack contact the tire), as shown in FIGS. 12 and 13; may contain portions that extend away from the tire (e.g., away from the front of the tire), as shown previously in FIGS. 8-11; and may contain mounting features (e.g., holes, spaces, gaps, groves, slots, notches, screw holes, screws, brackets, mounts, and/or other mounting features) that are MOLLE standard and/or non-MOLLE standard across its mounting surfaces as well as its frame, as also shown in FIGS. 8-11.

Adjustable tire rack 100, described herein and shown in FIGS. 8-11, may contain a frame that is fixed in width (e.g., may contain side plates that are perpendicularly fixed, in a non-adjustable way, to a center plate, that is also non-adjustable, and/or may contain a fixed frame containing side plates and a center plate, where the side plates are perpendicular to the center plate). However, as shown in FIGS. 8-11, adjustable tire rack 100 may be adjustable to accommodate tires of various sizes by containing adjustable portions of side plates that engage with the tire (e.g., portions of the side plates on opposing sides may move inward toward each other or outward away from each other to contain tires of various diameters therebetween). Two of side plates 104 may contain portions that may be adjusted to fit tire 206 between them, then fastened with straps 128, 130, and/or 132 around, across, and/or through tire 206 and/or including its rim, thereby securing adjustable tire rack 100 to tire 206 (as later shown in FIGS. 12 and 13).

Adjustable tire rack 100 may also contain center plate 102, attached perpendicularly and between each of two side plates 104, as shown in FIGS. 8-11. Adjustable tire rack 100 may also contain one of wings 134, which may be a fixed extension of each of side plates 104, that extend away from center plate 102, as shown in FIGS. 8 and 9. Alternatively, wing 134 may be an attachable extension of side plate 104. Center plate 102; and two side plates 104, their tire engagement portions, and their wings 134 may be contained within frame 136, as shown in FIGS. 8-11, which may be a fixed frame. As shown in FIGS. 8 and 9, front member 138, which may be a fixed or attachable member between two of wings 134 (i.e., on opposing sides of adjustable tire rack 1), and rear upper member 140 and rear lower member 142, which may both be detachably connected to adjustable tire rack 100 onto two opposing side plates 104, may be connected to or by frame 136 to provide additional structural support to adjustable tire rack 100 (e.g., to increase its weight or load carrying capacity or otherwise provide additional structural support) and/or to provide additional mounting surfaces.

Adjustable tire rack 100, as shown in FIGS. 8-11, may contain center plate 102, as mentioned above, which may be a vertical plate with a mounting surface capable of extending across all or a portion of the front of large tire 206 (shown in FIGS. 8-10) or small tire 208 (shown in FIG. 11), at their widest portions (e.g., across the diameter of the tire, including the front of the rim and tire side walls). Center plate 102 may be contained within frame 136, as shown in FIGS. 8-11. Center plate 102 may contain holes, spaces, gaps, groves, slots, notches, and/or screw holes, as shown in FIGS. 8-11, that are both complaint with and non-compliant with (e.g., outside of) the MOLLE standard or system; and/or center plate 102 may contain screws, brackets, mounts, and/or other mounting features that are both compliant with and non-compliant with (e.g., outside of) the MOLLE standard or system to attach items for storage on adjustable tire rack 100.

Adjustable tire rack 100, as shown in FIGS. 8-11, may also contain two of side plates 104, as mentioned above, which may be vertical side plates with mounting surfaces that may extend across all or a portion of the sides or tread surfaces of large tire 206 (shown in FIGS. 8-10) or small tire 208 (shown in FIG. 11), may contain the tire therebetween, and may have mounting surfaces that are perpendicular to center plate 102's mounting surface, with one of side plate 104 on a first side of center plate 102 and one of side plate 104 on a second side of center plate 102, such that center plate 102 and two of side plates 104 surround a front side and two sides (e.g., tread surfaces) of large tire 206, as shown in FIGS. 8-10, or small tire 208, as shown in FIG. 11. Each side plate 104 may further contain wing 134, which may be a fixed extension (e.g., a fixed or permanent part) of side plate 104 that may extend away from tire 206 and center plate 102, as shown in FIGS. 8-11.

Alternatively, wing 134 may be a detachable extension of side plate 104. Each of wings 134 may add additional mounting surfaces to adjustable tire rack 100 by extending the mounting surface on each of side plates 104 beyond the portions of adjustable tire rack 100 that surround tire 206, as shown in FIGS. 8 and 9. Each of side plates 104 including wings 134 may contain holes, spaces, gaps, groves, slots, notches, and/or screw holes that are both compliant with and non-compliant with (e.g., outside of) the MOLLE standard or system; and/or each of side plates 104 including wings 134 may contain screws, brackets, mounts, and/or other mounting features that are both compliant with and non-compliant with (e.g., outside of) the MOLLE standard or system to attach items for storage on adjustable tire rack 100.

As shown in FIGS. 10 and 11, side plate 104 may contain bracket 106, which may contain fixed portions and adjustable portions which may be used to mount adjustable tire rack 100 to tires of various diameters. Bracket 106 may contain upper engagement portion 108, which may engage with an upper portion of large tire 206, as shown in FIG. 10, or an upper portion of small tire 208, as shown in FIG. 11; and bracket 106 may also contain lower engagement portion 110, which may engage with a lower portion of large tire 206, as shown in FIG. 10, or a lower portion of small tire 208, as shown in FIG. 11. Two of brackets 106 on opposing side plates 104 (e.g., on either side of adjustable tire rack 100) may contain adjustable portions in each of their upper engagement portions 108 and lower engagement portions 110 that, together, may contain tire 206 therebetween.

FIGS. 10 and 11 show, in detail, the fixed and adjustable portions of upper engagement portion 108 adjusted to two tires of different sizes (e.g., large tire 206 in FIG. 10 and small tire 208 in FIG. 11), however, the same fixed and adjustable portions would also exist in lower engagement portion 110, as shown in FIG. 13. And a mirror image of side plate 104, with bracket 106, upper engagement portion 108, lower engagement portion 110, fixed portion 112, adjustable portion 114, screw 116, and slot 118, shown in an upper portion of side plate 104 in FIGS. 10 and 11 that exist on a first side of adjustable tire rack 100, may also exist on a second side of adjustable tire rack 100, as shown in FIGS. 12 and 13. The description below of fixed portion 112, adjustable portion 114, screw 116, and slot 118, shown in detail in an upper portion of a first side of adjustable tire rack 100 would also apply to a lower portion of the first side of adjustable tire rack 100, and to both the upper and lower portions of a second side of adjustable tire rack 100 (i.e., portions 112 and 114, screw 116, and slot 118 would be present in upper engagement portion 108 and lower engagement portion 110 of bracket 106 on side plate 104 on a first side of adjustable tire rack 100 and would also be present in upper engagement portion 108 and lower engagement portion 110 of bracket 106 on side plate 104 on a second side of adjustable tire rack 100 that, together, may be adjusted to fit tires of various diameters, as described below). Upper engagement portion 108 shown in FIG. 10 and lower engagement portion 110 may each contain fixed portion 112, which may be non-adjustable portions of side plate 104 (e.g., fixed portions of side plate 104 or frame 136 that contains side plate 104) to which adjustable portions 114 may be fastened to and at various positions to accommodate various tire diameters.

Fixed portion 112 may contain slot 118, which may be a slot, track, groove, rail, or several holes at various positions that screw 116 on adjustable portion 114, which may be a hand screw, thumb screw, bolt, nut, and/or any other type of fastening mechanism may be able to slide along or be positioned at and fastened, as shown in FIGS. 10 and 11. Alternatively adjustable portion 114 may contain a slot, track, grove, rail, or several holes at various positions that a screw on fixed portion 112 may be able to slide along or be positioned at and fastened. As shown in FIG. 10, each of brackets 106 may be adjusted to fit large tire 206, by loosening each of screws 116 on each adjustable portion 114 that is passing through one of slots 118 on each fixed portion 112, and moving adjustable portions 114 on opposing sides away each other, then fastening each of screws 116 through one of slots 118, securing each adjustable portion 114 to a respective fixed portion 112 and onto large tire 206. As shown in FIG. 11, each of brackets 106 may be adjusted to fit small tire 208, by loosening each of screws 116 on each adjustable portion 114 that is passing through one of slots 118 on each fixed portion 112, and moving adjustable portions 114 on opposing sides toward each other, then fastening each of screws 116 through one of slots 118, securing each adjustable portion 114 to a respective fixed portion 112 and onto small tire 208.

As shown in FIG. 10, two of brackets 106 (i.e., specifically each bracket's adjustable portions 114 in its upper engagement portion 108 and lower engagement portion 110) may be at their furthest position from each other at adjustable tire rack 100's widest position to accommodate large tire 206. As shown in FIG. 11, two of brackets 106 (i.e., specifically each bracket's adjustable portions 114 in its upper engagement portion 108 and lower engagement portion 110) may be at their closest position to each other at adjustable tire rack 100's narrowest position to accommodate small tire 208. As mentioned above, adjustable tire rack 100's tire engagement portions may be adjusted to their widest position shown in FIG. 10, their narrowest position shown in FIG. 11, or a position between those positions shown in FIGS. 10 and 11.

Each adjustable portion 114 in upper engagement portion 108 and lower engagement portion 110 may be pivotable or may contain a pivotable tire contact portion to fit the curvature of various tire sizes (e.g., various diameters) and/or to adjust to various vertical positions adjustable tire rack 100 may be positioned at with respect to a tire (e.g., at or near the top, at or near the center, at or near the bottom, or at any other position on the tire), as shown in FIGS. 12 and 13. As shown in FIG. 12, adjustable portions 114 in upper engagement portions 108 may contain first slots 120; and, as shown in FIG. 13, adjustable portions 114 in lower engagement portions 110 may contain second slots 122. Slots 120 and 122 may be slots capable of accepting strap 128 passed through them as well as around the tire (e.g., around the circumference of the tire) to detachably connect adjustable tire rack 100 to tire 206, as shown in FIGS. 12 and 13.

As shown in FIG. 12, adjustable portions 114 in upper engagement portions 108 may further contain third slots 124; and, as shown in FIG. 13, adjustable portions 114 in lower engagement portions 110 may further contain fourth slots 126. Slots 124 and 126 may allow straps 130 and 132, respectively, to be passed through them as well as around the sides of tire 206 (e.g., across tread surfaces, front, and rear of the tire) and through the tire (e.g., including its rim) to also detachably connect adjustable tire rack 100 to tire 206, as shown in FIGS. 12 and 13. Alternatively, strap 130 may pass through slot 124 on a first side of adjustable tire rack 100, through a second slot 124 on a second side of adjustable tire rack 1, as well as around the front, back, and sides (e.g., tread surfaces), near the top, of tire 206, also securing adjustable tire rack 100 to tire 206. Similarly, strap 132 may pass through slot 126 on a first side of adjustable tire rack 100, through slot 126 on a second side of adjustable tire rack 100, as well as around the front, back, and sides (e.g., tread surfaces), near the bottom, of tire 206, also securing adjustable tire rack 100 to tire 206. Alternatively, a first strap may pass diagonally through slot 124 on an upper side of a first side of adjustable tire rack 100, through slot 126 on a lower side of a second side of adjustable tire rack 100, as well as around the front, back, and sides (e.g., tread surfaces) near both the top and bottom of a tire; and a second strap may pass through slot 126 on a lower side of a first side of adjustable tire rack 100, through slot 124 on an upper side of a second side of adjustable tire rack 100, as well as around the front, back, and sides (e.g., tread surfaces) near both the bottom and top of a tire to secure adjustable tire rack 100 to the tire using two straps in a crisscross pattern. One or more of straps 128, 130, or 132 by itself or in combination with other straps may be used to secure adjustable tire rack 100 to tire 206.

As previously mentioned and shown, adjustable tire rack 100 may contain, attached to frame 136, side plate 104, and/or wing 134, additional cross members that may provide further structural support to frame 136, side plate 104 and/or wing 134. As shown in FIGS. 8 and 9, front member 138 may be a cross member that extends between and connects with two of wings 134 on side plates 104 on opposing sides of adjustable tire rack 100. Front member 138 may be fixed (e.g., welded) or fastened (e.g., by screws or a similar fastening mechanism) to two of wings 134. In this position, front member 138 may increase the structural rigidity of wings 134, side plates 104, and/or frame 136. Front member 138 may also contain mounting features (e.g., holes, spaces, gaps, groves, slots, notches, screw holes, screws, brackets, mounts, and/or other mounting features) for mounting items for storage and/or other items such as accessories, accessory taillights, a relocated license plate, or a relocated backup camera, if any of those items on the vehicle are blocked by the rack and/or items stored on the rack and/or if it would be beneficial to install any of those items on the rack.

As shown in FIGS. 8 and 9, rear upper member 140 and rear lower member 142 may similarly be attached to and between two opposing side plates 104. Rear upper member 140 and rear lower member 142 may be fastened (e.g., by screws or a similar fastening mechanism) at or near the rear upper corners and rear lower corners, respectively, of two side plates 104. Installation of members 140 and 142 may occur after installation of adjustable tire rack 100 onto tire 206, so that adjustable tire rack 100 may be able to fit around tire 206 without first being obstructed by members 140 and 142. Once installed, members 140 and 142 may provide additional structural rigidity to the rear sections of side plates 104, and/or frame 136. Rear upper member 140 and/or rear lower member 142 may may also contain mounting features (e.g., holes, spaces, gaps, groves, slots, notches, screw holes, screws, brackets, mounts, and/or other mounting features) for mounting items for storage or for mounting accessories. It may not be necessary for cross members 138, 140, and/or 142 to be installed or be present for adjustable tire rack 100 to function as an adjustable tire rack, however, it may provide additional mounting locations for items as well as support to carry heavier, longer, wider, and/or odd shaped loads, if they are installed.

The frame, cross members, and mounting surfaces of adjustable tire rack 100 may be comprised mainly of aluminum, steel, another metal or alloy, another suitable, strong, and rigid material, and/or a combination of materials. The smaller components of adjustable tire rack 100, such as the tire engagements portions, may be comprised mainly of aluminum, steel, another metal or alloy, plastic, rubber, composite material, another suitable material, and/or a combination of materials. The straps used to secure adjustable tire rack 100 to a tire may be comprised mainly of nylon, polyester, another strapping material, and/or a combination of materials. The components that comprise adjustable tire rack 100 may be welded together, screwed together, strapped together, fastened together by another method, and/or fastened together by a combination of methods.

What is claimed is:

1. An adjustable tire rack comprising:
a center plate; and
first and second side plates mounted perpendicularly to the center plate and configured to receive a tire therebetween,
wherein a part of the first and second side plates extends away from the tire and the center plate.

2. The adjustable tire rack of claim 1, further comprising a leaf that is configured to adjust a width of the center plate.

3. The adjustable tire rack of claim 1, further comprising a bracket mounted to each of the first and second side plates, the bracket being configured to engage an outer curvature of the tire.

4. The adjustable tire rack of claim 3, wherein each of the first and second side plates comprises two pivotable brackets.

5. The adjustable tire rack of claim 4, wherein each of the pivotable brackets comprises an upper engagement part and a lower engagement part that are configured to engage the outer curvature of the tire.

6. The adjustable tire rack of claim 3, wherein the bracket comprises first and second slots configured to receive a strap for fastening the tire to the rack.

7. The adjustable tire rack of claim 6, wherein the first and second slots are positioned adjacent to the upper engagement part and the lower engagement part, respectively.

8. The adjustable tire rack of claim 7, wherein the bracket comprises third and fourth slots positioned at a wall of the bracket that is perpendicular to the first and second slots, wherein the first and second slots are configured to receive a strap that extends around a curvature of the tire and the third and fourth slots are configured to receive a strap that extends around sides of the tire.

9. The adjustable tire rack of claim 1, wherein the center plate comprises two center plate halves, which are positioned between the first and second side plates in a load-bearing position and are adjustable in width to accommodate tires of different sizes.

10. An adjustable tire rack comprising:
a center plate; and
a pivotable bracket mounted to each of a first and a second side plates mounted perpendicularly to the center plate and configured to receive a tire therebetween,
wherein each pivotable bracket is configured to engage an outer curvature of a tire and pivot based on the outer curvature of the tire; and
wherein each pivotable bracket comprises first and second slots configured to receive a strap for fastening the tire to a mounting surface.

11. The adjustable tire rack of claim 10, wherein the pivotable bracket comprises an upper engagement part and a lower engagement part configured to engage the outer curvature of the tire.

12. The adjustable tire rack of claim 11, wherein the first and second slots of the pivotable bracket are positioned adjacent to the upper engagement part and the lower engagement part, respectively.

13. The adjustable tire rack of claim 10, further comprising third and fourth slots on the pivotable bracket, positioned on a wall perpendicular to the first and second slots, wherein the first and second slots are configured to receive a strap that extends around the curvature of the tire, and the third and fourth slots are configured to receive a strap that extends around sides of the tire.

14. An adjustable tire rack comprising:
a center plate, two center plate halves; and
first and second side plates mounted perpendicularly to the center plate and configured to receive a tire therebetween,
wherein a part of the first and second side plates extends away from the tire and the center plate.

15. The adjustable tire rack of claim 14, further comprising a leaf that is configured to adjust the width of the center plate.

16. The adjustable tire rack of claim 14, further comprising a bracket mounted to each of the first and second side plates, the bracket being configured to engage an outer curvature of the tire.

17. The adjustable tire rack of claim 16, wherein each of the first and second side plates comprises two pivotable brackets.

18. The adjustable tire rack of claim 17, wherein each of the pivotable brackets includes an upper engagement part and a lower engagement part that are configured to engage the outer curvature of the tire.

19. The adjustable tire rack of claim 16, wherein first and second slots of the bracket are positioned adjacent to the upper engagement part and the lower engagement part, respectively.

20. The adjustable tire rack of claim 19, further comprising third and fourth slots on the bracket, positioned on a wall perpendicular to the first and second slots, wherein the first and second slots are configured to receive a strap that extends around the curvature of the tire, and the third and fourth slots are configured to receive a strap that extends around sides of the tire.
